(19) United States
(12) Patent Application Publication
(10) Pub. No.: US 2026/0342882 A1
(43) Pub. Date: Oct. 29, 2026

(54) INTEGRATION OF METAVERSE SERVICES

(71) Applicant: International Business Machines Corporation, Armonk, NY (US)

(72) Inventors: Hamid Majdabadi, OTTAWA (CA); Alma Gabriela Ramirez Enriquez, Guadalajara (MX); Sarbajit Kumar Rakshit, Kolkata (IN); Carolina Garcia Delgado, Zapopan (MX)

(21) Appl. No.: 19/190,217

(22) Filed: Apr. 25, 2025

(51) Int. Cl. H04L 67/131; H04L 41/5006; H04L 67/306

(52) U.S. Cl. CPC H04L 67/131; H04L 41/5006; H04L 67/306

(57) ABSTRACT

Integration of metaverse services includes identifying a first set of metaverse services of a first metaverse environment. The first set of metaverse services is integrated with a second set of metaverse services of a second metaverse environment. Profile data associated with a user is received. A set of parameters is obtained based on the received profile data. An association between the obtained set of parameters and the integrated first set of metaverse services is determined. A digital contract is generated based on the determined association. Context data associated with the second set of metaverse services is received. The digital contract is executed based on the reception of the context data and a metaverse service of the first set of metaverse services is initiated based on the digital contract.

### BACKGROUND

The disclosure relates to metaverse and more particularly, to metaverse services.

Metaverse refers to a virtual, immersive, and interconnected digital environment where users interact with digital content and additional participants of the metaverse through avatars, augmented reality (AR), virtual reality (VR), and additional advanced technologies. In alternate words, the metaverse represents a convergence of physical and digital worlds, enabling seamless interaction across virtual spaces. In recent years, the metaverse has gained significant attention due to potential applications across industries including entertainment, education, e-commerce, and enterprise collaboration.

### SUMMARY

In various embodiments of the disclosure, a computer-implemented method for integration of the metaverse services. The computer-implemented method includes identifying, by a computer, a first set of metaverse services of a first metaverse environment. The first metaverse environment is associated with a first distributed ledger. The computer-implemented method further includes integrating, by the computer, the identified first set of metaverse services with a second set of metaverse services of a second metaverse environment. The second metaverse environment is associated with a second distributed ledger. The computer-implemented method further includes receiving, by the computer, profile data associated with a user. The user is associated with the second metaverse environment. The computer-implemented method further includes obtaining, by the computer, a set of parameters from the received profile data. The computer-implemented method further includes determining, by the computer, an association between the obtained set of parameters and the integrated first set of metaverse services. The computer-implemented method further includes generating, by the computer, a digital contract based on the determined association. The computer-implemented method further includes receiving, by the computer, context data associated with the second set of metaverse services. The generated digital contract is executed based on the reception of the context data. The computer-implemented method further includes initiating, by the computer, a metaverse service of the integrated first set of metaverse services based on the executed digital contract. The metaverse service is initiated with the second set of metaverse services.

In various embodiments of the disclosure, a computer system is described. The computer system includes a processor set, one or more computer-readable storage media, and program instructions stored on the one or more computer-readable storage media. The program instructions executable by the processor set to cause the processor set to perform a method for integration of the metaverse services.

In various embodiments of the disclosure, a computer-program product for integration of the metaverse services is described.

Additional technical features and benefits are realized through the techniques of the disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The following description will provide details of preferred embodiments with reference to the following figures wherein:

FIG. 1 is a diagram that illustrates a computing environment for the integration of metaverse services, in accordance with an embodiment of the disclosure;

FIG. 2 is a diagram that illustrates an environment for integration of the metaverse services, in accordance with an embodiment of the disclosure;

FIGS. 3A and 3B are diagrams that collectively illustrate exemplary operations for the integration of the metaverse services, in accordance with an embodiment of the disclosure;

FIG. 4A is a diagram that illustrates a first exemplary scenario for the integration of the metaverse services, in accordance with an embodiment of the disclosure;

FIG. 4B is a diagram that illustrates a second exemplary scenario for the integration of the metaverse services, in accordance with an embodiment of the disclosure; and

FIGS. 5A and 5B are diagrams that collectively illustrate a flowchart of an exemplary method for integration of the metaverse services, in accordance with an embodiment of the disclosure.

### DETAILED DESCRIPTION

A metaverse environment refers to a virtual, interactive, and immersive digital space that enables users to engage in various activities, services, and transactions. The metaverse environment is built on a networked computing infrastructure supporting real-time communication, three-dimensional (3D) simulation, and data management. The metaverse environment can be associated with a specific domain such as gaming, education, healthcare, or commerce, and may integrate various technologies including virtual reality (VR), augmented reality (AR), mixed reality (MR), and the like. However, a user often engages with multiple metaverse environments, each requiring separate authentication, service configuration, and data synchronization. This fragmented approach creates inefficiencies, increased complexity, and unsatisfactory user engagement as the user must repeatedly log in to separate accounts associated with the multiple metaverse environments to access different metaverse services offered by the corresponding metaverse environment.

Conventional systems attempt metaverse integrations by allowing various metaverse services continuously on a single interface. This allows a user to freely choose and interact between the various metaverse services. However, allowing various metaverse services at once on a single interface may be resource-consuming. Further, the user may be overwhelmed by the multiple service options that may be provided to him.

To address these issues, a system that can integrate metaverse services is disclosed. The system receives the preference data of the user associated with a first metaverse environment. The system further shortlists a second metaverse environment based on the preference data. Further, the system identifies a second set of metaverse services of the second metaverse environment that are compatible with the first set of metaverse services of the first metaverse environment. The system further integrates the second set of metaverse services with the first set of metaverse services. Further, the system receives profile data associated with a user. Based on the received profile data, the system obtains a set of parameters. The system further determines an association between the obtained set of parameters and the integrated first set of metaverse services. The system further generates a digital contract based on the determined association. The system further receives context data associated with the first set of metaverse services. Based on the received context data, the generated digital contract is executed. Further, based on the execution of the generated digital contract, the system initiates a metaverse service of the integrated second set of metaverse services.

The disclosed system provides a robust and scalable framework for automated metaverse service orchestration by leveraging smart contract execution and context-aware triggers. By utilizing a distributed ledger architecture, the system ensures secure, verifiable, and tamper-resistant service activation across interconnected metaverse environments. The association between the set of parameters and the integrated second set of metaverse services ensures that metaverse service initiation is accurate and data-driven. The disclosed system further enables the dynamic initiation of metaverse services through smart contract execution. The smart contract is executed based on an assessment of context data. By processing user behavior, preferences, historical data, and context data, the system autonomously initiates metaverse services ensuring timely and precise service activation. The smart contract enforces a set of conditions, eliminating manual intervention while maintaining security via distributed ledger authentication. By automating metaverse service initiation, the system enhances computational efficiency and optimizes resource allocation, making metaverse interactions more scalable and adaptive. Additionally, the system enables seamless cross-platform service integration through standardized application programming interfaces (APIs) and distributed ledger interoperability. This ensures reduced latency and enhanced system scalability, providing a robust framework for adaptive and intelligent metaverse service orchestration.

In various embodiments of the disclosure, a computer-implemented method for integration of the metaverse services. The computer-implemented method includes identifying, by a computer, a first set of metaverse services of a first metaverse environment. The first metaverse environment is associated with a first distributed ledger. The computer-implemented method further includes integrating, by the computer, the identified first set of metaverse services with a second set of metaverse services of a second metaverse environment. The second metaverse environment is associated with a second distributed ledger. The computer-implemented method further includes receiving, by the computer, profile data associated with a user. The user is associated with the second metaverse environment. The computer-implemented method further includes obtaining, by the computer, a set of parameters from the received profile data. The computer-implemented method further includes determining, by the computer, an association between the obtained set of parameters and the integrated first set of metaverse services. The computer-implemented method further includes generating, by the computer, a digital contract based on the determined association. The computer-implemented method further includes receiving, by the computer, context data associated with the second set of metaverse services. The generated digital contract is executed based on the reception of the context data. The computer-implemented method further includes initiating, by the computer, a metaverse service of the integrated first set of metaverse services based on the executed digital contract. The metaverse service is initiated with the second set of metaverse services.

In various embodiments of the disclosure, the computer-implemented method further includes receiving, by the computer, feedback data based on the initiation of the metaverse service. The computer-implemented method further includes logging, by the computer, the received feedback data on the second distributed ledger. The computer-implemented method further includes updating, by the computer, the association between the obtained set of parameters and the integrated first set of metaverse services. The association is updated based on the logged feedback data. The computer-implemented method further includes updating, by the computer, the digital contract based on the updated association.

In various embodiments of the disclosure, the computer-implemented method further includes determining, by the computer, a success rate associated with the initiated metaverse service. The success rate is determined based on the received feedback data. The computer-implemented method further includes logging, by the computer, the determined success rate on the second distributed ledger. The association is updated based on the logged success rate.

In various embodiments of the disclosure, the computer-implemented method further includes generating, by the computer, a set of service level agreements (SLAs) between the first metaverse environment and the second metaverse environment. The set of SLAs is generated based on the identification of the first set of metaverse services. The computer-implemented method further includes integrating, by the computer, the identified first set of metaverse services with the second set of metaverse services. The integration is based on the generated set of SLAs.

In various embodiments of the disclosure, the generated set of SLAs includes at least one of a commercial agreement, a technical agreement, an operational agreement, or a governance agreement.

In various embodiments of the disclosure, the computer-implemented method further includes generating, by the computer, a trigger based on the reception of the context data. The generated digital contract is executed based on the generated trigger.

In various embodiments of the disclosure, the integration is based on at least one of application programming interfaces (APIs), middleware applications, or data mapping strategies.

In various embodiments of the disclosure, the first distributed ledger is identical to the second distributed ledger.

In various embodiments of the disclosure, the context data includes at least one of interaction data, behavioral data, physiological data, environmental data, transaction data, communication data, or external influences.

In various embodiments of the disclosure, the obtained set of parameters includes at least one of behavioral patterns, historical interactions, preference indicators, and transaction history.

In various embodiments of the disclosure, a computer system is described. The computer system includes a processor set, one or more computer-readable storage media, and program instructions stored on the one or more computer-readable storage media. The program instructions executable by the processor set to cause the processor set to perform a method for integration of the metaverse services. The program instructions further cause the processor set to identify a first set of metaverse services of a first metaverse environment. The first metaverse environment is associated with a first distributed ledger. The program instructions further cause the processor set to integrate the identified first set of metaverse services with a second set of metaverse services of a second metaverse environment. The second metaverse environment is associated with a second distributed ledger. The program instructions further cause the processor set to receive profile data associated with a user. The user is associated with the second metaverse environment. The program instructions further cause the processor set to obtain a set of parameters from the received profile data. The program instructions further cause the processor set to determine an association between the obtained set of parameters and the integrated first set of metaverse services. The program instructions further cause the processor set to generate a digital contract based on the determined association. The program instructions further cause the processor set to receive context data associated with the second set of metaverse services. The generated digital contract is executed based on the reception of the context data. The program instructions further cause the processor set to initiate a metaverse service of the integrated first set of metaverse services based on the executed digital contract. The metaverse service is initiated with the second set of metaverse services.

In various embodiments of the disclosure, the program instructions further cause the processor set to receive feedback data based on the initiation of the metaverse service. The program instructions further cause the processor set to log the received feedback data on the second distributed ledger. The program instructions further cause the processor set to update the association between the obtained set of parameters and the integrated first set of metaverse services. The association is updated based on the logged feedback data. The program instructions further cause the processor set to update the digital contract based on the updated association.

In various embodiments of the disclosure, the program instructions further cause the processor set to determine a success rate associated with the initiated metaverse service. The success rate is determined based on the received feedback data. The program instructions further cause the processor set to log the determined success rate on the second distributed ledger. The association is updated based on the logged success rate.

In various embodiments of the disclosure, the program instructions further cause the processor set to generate a set of service level agreements (SLAs) between the first metaverse environment and the second metaverse environment. The set of SLAs is generated based on the identification of the first set of metaverse services. The program instructions further cause the processor set to integrate the identified first set of metaverse services with the second set of metaverse services. The integration is based on the generated set of SLAs.

In various embodiments of the disclosure, the generated set of SLAs includes at least one of a commercial agreement, a technical agreement, an operational agreement, or a governance agreement.

In various embodiments of the disclosure, the program instructions further cause the processor set to generate a trigger based on the reception of the context data. The generated digital contract is executed based on the generated trigger.

In various embodiments of the disclosure, the integration is based on at least one of application programming interfaces (APIs), middleware applications, or data mapping strategies.

In various embodiments of the disclosure, the first distributed ledger is identical to the second distributed ledger.

In various embodiments of the disclosure, the context data includes at least one of interaction data, behavioral data, physiological data, environmental data, transaction data, communication data, or external influences.

In various embodiments of the disclosure, a computer-program product is described. The computer-program product includes one or more computer-readable storage media and program instructions stored on the one or more computer-readable storage media to perform operations for integration of the metaverse services. The operations include identifying a first set of metaverse services of a first metaverse environment. The first metaverse environment is associated with a first distributed ledger. The operations further include integrating the identified first set of metaverse services with a second set of metaverse services of a second metaverse environment. The second metaverse environment is associated with a second distributed ledger. The operations further include receiving profile data associated with a user. The user is associated with the second metaverse environment. The operations further include obtaining a set of parameters from the received profile data. The operations further include determining an association between the obtained set of parameters and the integrated first set of metaverse services. The operations further include generating a digital contract based on the determined association. The operations further include receiving context data associated with the second set of metaverse services. The generated digital contract is executed based on the reception of the context data. The operations further include initiating a metaverse service of the integrated first set of metaverse services based on the executed digital contract. The metaverse service is initiated with the second set of metaverse services.

Additional technical features and benefits are realized through the various processes of the disclosure. Embodiments and aspects of the disclosure are described in detail herein and are considered a part of the claimed subject matter.

Various aspects of the disclosure are described by narrative text, flowcharts, block diagrams of computer systems, and/or block diagrams of the machine logic included in computer-program product (CPP) embodiments. With respect to any flowcharts, depending upon the technology involved, the operations can be performed in a different order than what is shown in a given flowchart. For example, again depending upon the technology involved, two operations shown in successive flowchart blocks could be performed in reverse order, as a single integrated operation, concurrently, or in a manner at least partially overlapping in time.

A computer-program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium could be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the disclosure, is not to be construed as storage in the form of transitory signals per se, such as radio waves or additional freely propagating electromagnetic waves, electromagnetic waves propagating through a waveguide, light pulses passing through a fiber optic cable, electrical signals communicated through a wire, and/or additional transmission media. As will be understood by those of skill in the art, data is typically moved at some occasional points in time during normal operations of a storage device, such as during access, de-fragmentation, or garbage collection, but this does not render the storage device as transitory because the data is not transitory while being stored.

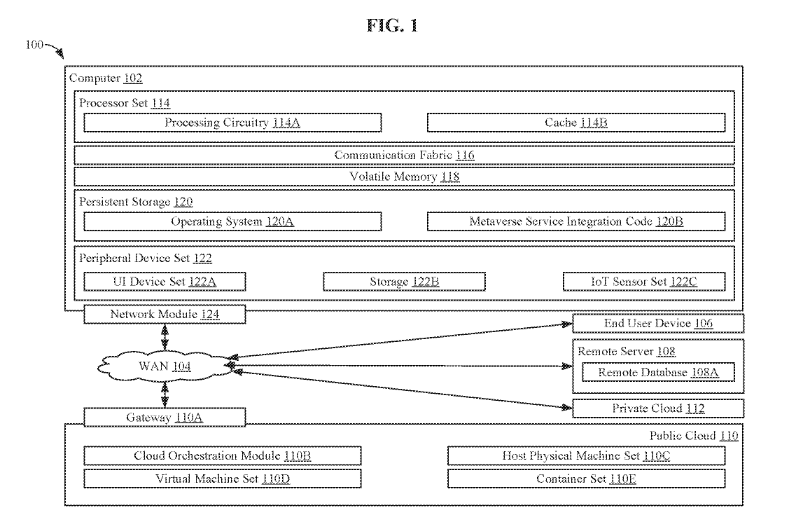

FIG. 1 is a diagram that illustrates a computing environment for integration of metaverse services, in accordance with an embodiment of the disclosure. With reference to FIG. 1, there is shown a computing environment 100 that contains an example of an environment for the execution of at least some of the computer code involved in performing the disclosed methods, such as a metaverse service integration code 120B. In addition to the metaverse service integration code 120B, computing environment 100 includes, for example, a computer 102, a wide area network (WAN) 104, an end user device (EUD) 106, a remote server 108, a public cloud 110, and a private cloud 112. In this embodiment of the disclosure, the computer 102 includes a processor set 114 (including a processing circuitry 114A and a cache 114B), a communication fabric 116, a volatile memory 118, a persistent storage 120 (including an operating system 120A and the metaverse service integration code 120B, as identified above), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a mainframe computer, a quantum computer, a virtual machine, or any form of a computer or a mobile device now known or to be developed in the future that may be configured for running a program, accessing a network or querying a database, such as the remote database 108A. As is well understood in the art of computer technology, and depending upon the technology, the performance of a computer-implemented method may be distributed among multiple computers and/or between multiple locations. In an embodiment, in this presentation of the computing environment 100, detailed discussion is focused on a single computer, specifically the computer 102, to keep the presentation as simple as possible. The computer 102 may be located in a cloud, even though not shown in a cloud in FIG. 1. In an alternate embodiment, the computer 102 may not be in a cloud except to any extent as may be affirmatively indicated.

The processor set 114 includes one, or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B may be memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the disclosed methods”). These computer-readable program instructions are stored in various types of computer-readable storage media, such as the cache 114B and the additional storage media discussed below. The program instructions, and associated data, are accessed by the processor set 114 to control and direct the performance of the disclosed methods. In computing environment 100, at least some of the instructions for performing the disclosed methods may be stored in the dynamic modification of the metaverse service integration code 120B in persistent storage 120.

The communication fabric 116 is the signal conduction path that allows the various components of computer 102 to intercommunicate. Typically, this fabric is made of switches and electrically conductive paths, such as the switches and electrically conductive paths that make up buses, bridges, physical input/output ports, and the like. Various types of signal communication paths may be used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by a random access, but this is not general case unless affirmatively indicated. In the computer 102, the volatile memory 118 is located in a single package and is internal to the computer 102, but alternatively or additionally, the volatile memory 118 may be distributed over multiple packages and/or located externally with respect to the computer 102.

The persistent storage 120 is any form of non-volatile storage for computers that is now known or to be developed in the future. The non-volatility of this storage means that the stored data is maintained regardless of whether power is being supplied to the computer 102 and/or directly to the persistent storage 120. The persistent storage 120 may be a read-only memory (ROM), but typically at least a portion of the persistent storage 120 allows writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The code included in the metaverse service integration code 120B typically includes at least some of the computer code involved in performing the disclosed methods.

The peripheral device set 122 includes the set of peripheral devices of the computer 102. Data communication connections between the peripheral devices and the additional components of the computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A may include components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B may be persistent and/or volatile. In some embodiments of the disclosure, the storage 122B may take the form of a quantum computing storage device for storing data in the form of qubits. In embodiments of the disclosure where the computer 102 may have a large amount of storage (for example, where the computer 102 locally stores and manages a large database) then this storage may be provided by peripheral storage devices designed for storing very large amounts of data, such as a storage area network (SAN) that is shared by multiple, geographically distributed computers. The IoT sensor set 122C is made up of sensors that can be used in Internet of Things applications. For example, a first sensor may be a thermometer, and a second sensor may be a motion detector.

The network module 124 is the collection of computer software, hardware, and firmware that allows the computer 102 to communicate with one or more computers through the WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In various embodiments of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the disclosed methods can typically be downloaded to the computer 102 from an external computer or external storage device through a network adapter card or network interface included in the network module 124.

The WAN 104 is a wide area network (for example, the internet) that may be configured for communicating computer data over non-local distances by any technology for communicating computer data, now known or to be developed in the future. In some embodiments of the disclosure, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is controlled by an end user (for example, a customer of an enterprise that operates the computer 102) and may take any of the forms discussed above in connection with the computer 102. The EUD 106 typically receives helpful and useful data from the operations of the computer 102. For example, in a hypothetical case where the computer 102 is designed to provide a recommendation to an end user, this recommendation would typically be communicated from the network module 124 of the computer 102 through the WAN 104 to the EUD 106. In this way, the EUD 106 can display, or alternatively present recommendations to an end user. In some embodiments of the disclosure, the EUD 106 may be a client device, such as a mainframe computer, a desktop computer, and so on.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by the one or more computers, such as the computer 102. For example, in a hypothetical case where the computer 102 is designed and programmed to provide a recommendation based on historical data, then this historical data may be provided to the computer 102 from the remote database 108A of the remote server 108.

The public cloud 110 is any computer system available for use by multiple entities that provides on-demand availability of computer system resources and/or additional computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments (VCEs) typically take the form of virtual machines from the virtual machine set 110D and/or containers from the container set 110E. In an embodiment, the VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows the public cloud 110 to communicate through the WAN 104.

Some further explanation of virtualized computing environments (VCEs) will now be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in the container. A computer-program running on an ordinary operating system can utilize resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to public cloud 110, except that the computing resources are only available for use by a single enterprise. While the private cloud 112 is depicted as being in communication with the WAN 104, in various embodiments of the disclosure, the private cloud 112 may be disconnected from the internet entirely and only accessible through a local/private network. A hybrid cloud is a composition of multiple clouds of different types (for example, private, community, or public cloud types), often respectively implemented by different vendors. Each cloud of the multiple clouds remains a separate and discrete entity, but the larger hybrid cloud architecture is bound together by standardized or proprietary technology that enables orchestration, management, and/or data/application portability between the multiple constituent clouds. In this embodiment of the disclosure, the public cloud 110 and the private cloud 112 are both part of a larger hybrid cloud.

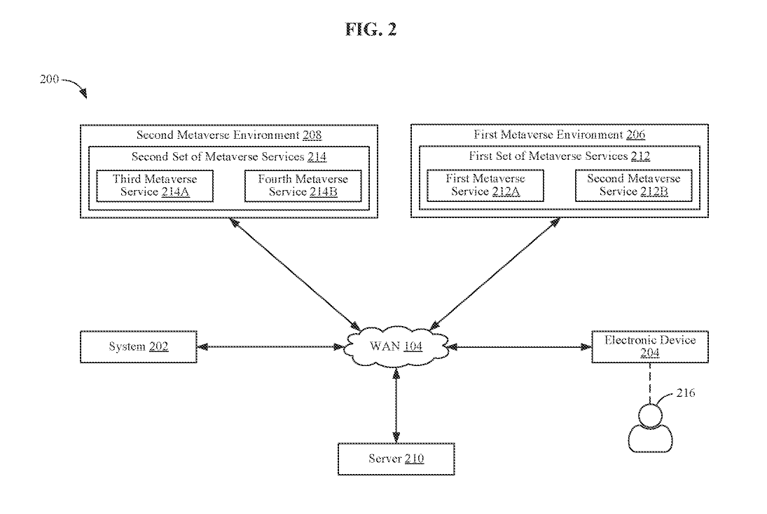

FIG. 2 is a diagram that illustrates an environment for integration of the metaverse services, in accordance with an embodiment of the disclosure. FIG. 2 is explained in conjunction with elements from FIG. 1. With reference to FIG. 2, there is shown a diagram of a network environment 200. The network environment 200 includes a system 202, an electronic device 204, a first metaverse environment 206, a second metaverse environment 208, and a server 210. The network environment 200 further includes the WAN 104 of FIG. 1. In an embodiment of the disclosure, the system 202 may be an exemplary embodiment of the computer 102 of FIG. 1.

The system 202 may include suitable logic, circuitry, interfaces, and/or code that may be configured for the integration of one or more metaverse environments. The system 202 may be configured to receive preference data of users associated with the first metaverse environment 206. The preference data may indicate the interest of the users, the requirements of the users, or past interactions of the users with one or more metaverse environments. For example, the preference data may include categories of interest such as gaming, educational awareness, finance, or healthcare. Based on the received preference data, the system 202 may be further configured to identify a plurality of metaverse environments that may be associated with one or more distributed ledgers.

A metaverse environment refers to a virtual, interactive, and immersive digital space that enables the users to engage in various activities, services, and transactions. The metaverse environment may be built on a networked computing infrastructure supporting real-time communication, three-dimensional (3D) simulation, and data management. In an embodiment, the metaverse environment may be associated with a specific domain such as gaming, education, healthcare, or commerce, and may integrate various technologies including virtual reality (VR), augmented reality (AR), mixed reality (MR), and the like.

A distributed ledger refers to a data storage and management system where data records are shared, replicated, and synchronized across multiple nodes or computing devices in a decentralized network. The distributed ledger is maintained via a consensus mechanism or protocol to ensure each node of the multiple nodes retains a verified and identical copy of ledger data. The distributed ledger ensures immutability, transparency, and fault tolerance, and is thereby used for secure transaction recording, and additional applications that may require trustless verification.

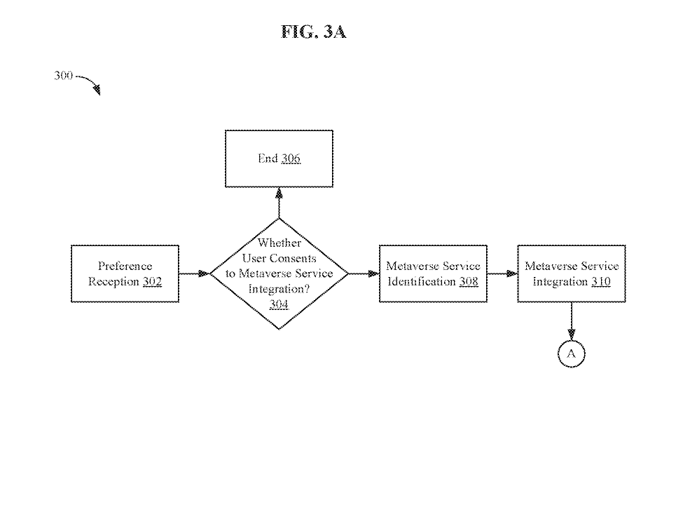

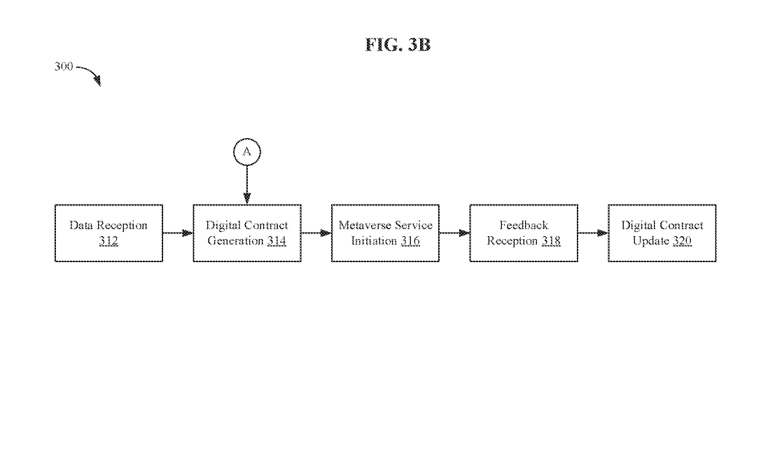

The system 202 may be further configured to provide integration among the plurality of metaverse environments to enhance user engagement and service effectiveness. In an embodiment, by integrating the plurality of metaverse environments, the system 202 provides a unified digital ecosystem that allows the users to access complementary metaverse services offered by various metaverse environments through a single collaborative interface. Details about the integration of the plurality of metaverse environments (e.g., a plurality of metaverse services offered by the plurality of metaverse environments) are provided, for example in FIG. 3A and 3B.

The electronic device 204 may include suitable logic, circuitry, interfaces, and/or code that may be configured to enable a user 216 to access one or more metaverse environments. Examples of the electronic device 204 may include, but are not limited to, virtual reality (VR) headsets, augmented reality (AR) headsets, gaming consoles, a smartphone, a cellular phone, a mobile phone, and the like. The electronic device 204 may be configured to receive the preference data of the user 216. The electronic device 204 may be further configured to provide the preference data to the system 202. The electronic device 204 may include a display screen. In an embodiment, a metaverse environment of the plurality of metaverse environments may be rendered on the display screen. For the sake of brevity, the network environment 200 is shown to include the electronic device 204 and the user 216, in actual implementation the network environment 200 may include a set of electronic devices (identical to the electronic device 204) and a set of users associated with the set of electronic devices.

The first metaverse environment 206 may correspond to a primary digital ecosystem associated with the user 216. In an embodiment, the first metaverse environment 206 is offered by a first service provider. The first service provider may correspond to a technology company specializing in virtual reality and blockchain-based solutions. Further, the user 216 may have a first user account associated with the first metaverse environment 206. The first user account may serve as a unique digital identity within the first metaverse environment 206. The first user account may store user-related data, including authentication credentials, profile information, preferences, transaction history, access permissions, and the like. In an embodiment, the user-related data may be securely recorded on the first distributed ledger to ensure immutability, transparency, and decentralized verification. For example, the first distributed ledger (e.g., a first blockchain network) may store hashed representations of user authentication credentials to prevent unauthorized access while maintaining privacy. Additionally, transaction records related to digital asset purchases, virtual interactions, or service subscriptions may be cryptographically signed and recorded on the first distributed ledger to ensure data integrity.

The second metaverse environment 208 may correspond to a secondary digital ecosystem associated with the user 216. In an embodiment, the second metaverse environment 208 is offered by a second service provider. The second service provider may correspond to a technology company specializing in virtual reality and blockchain-based solutions. Further, the user 216 may have a second user account associated with the second metaverse environment 208. The second user account may serve as a unique digital identity within the second metaverse environment 208. The second user account may store user-related data, including authentication credentials, profile information, preferences, transaction history, access permissions, and the like. In an embodiment, the user-related data may be securely recorded on the second distributed ledger to ensure immutability, transparency, and decentralized verification. For example, the second distributed ledger (e.g., a second blockchain network) may store hashed representations of user authentication credentials to prevent unauthorized access while maintaining privacy. Additionally, transaction records related to digital asset purchases, virtual interactions, or service subscriptions may be cryptographically signed and recorded on the second distributed ledger to ensure data integrity.

The server 210 may include suitable logic, circuitry, interfaces, and/or code that may be configured to receive the preference data from the electronic device 204. Upon receiving the preference data, the server 210 may be further configured to store the preference data. In an embodiment, the server 210 may be configured to store the first metaverse environment 206. The server 210 may be implemented as a cloud server and may execute operations through web applications, cloud applications, HTTP requests, repository operations, file transfer, and the like. Additional example implementations of the server 210 may include, but are not limited to, a database server, a file server, a web server, a media server, an application server, a mainframe server, or a cloud computing server.

In an embodiment of the disclosure, the server 210 may be implemented as a plurality of distributed cloud-based resources by use of several technologies that are well known to those ordinarily skilled in the art. A person with ordinary skill in the art will understand that the scope of the disclosure may not be limited to the implementation of the server 210 and the system 202 as two separate entities. In certain embodiments, the functionalities of the server 210 can be incorporated in its entirety or at least partially in the system 202, without a departure from the scope of the disclosure.

The first metaverse environment 206 may include a first set of metaverse services 212. The first set of metaverse services 212 may correspond to a range of digital services that are directly accessible to the user 216. The first set of metaverse services 212 may be designed to enhance user engagement, provide virtual interactions, and provide immersive experiences tailored to the user’s preferences. In an embodiment, the first set of metaverse services 212 may include a virtual workspace that allows the user 216 to engage in professional activities, a social networking hub where the user 216 can interact with additional participants in the first metaverse environment 206, or a content consumption platform for streaming digital media.

In an embodiment, the first set of metaverse services 212 may include a first metaverse service 212A and a second metaverse service 212B. The first metaverse service 212A and the second metaverse service 212B may be integrated within the first metaverse environment 206 and may operate using a set of service protocols and interfaces. Further, the first metaverse service 212A and the second metaverse service 212B may leverage blockchain-based authentication mechanisms to validate access of the user 216 and maintain transaction records associated with the user 216. Additionally, the first metaverse environment 206 may provide a secure framework for handling digital assets, including virtual goods, cryptocurrencies, and non-fungible tokens (NFTs), ensuring seamless user interactions within the ecosystem.

The second metaverse environment 208 may include a second set of metaverse services 214. The second set of metaverse services 214 may correspond to a range of digital services that are directly accessible to the user 216. The second set of metaverse services 214 may be designed to enhance user engagement, provide virtual interactions, and provide immersive experiences tailored to the user’s preferences. In an embodiment, the second set of metaverse services 214 may function as an auxiliary digital space that enhances or supplements the first set of metaverse services 212. For example, the second set of metaverse services 214 may include advanced financial tools such as blockchain-based decentralized finance (DeFi) applications, automated investment platforms, or cryptocurrency exchanges that enable seamless financial transactions. Additionally, the second set of metaverse services 214 may include entertainment platforms, such as virtual concert arenas, gaming universes, or interactive storytelling experiences that provide the user 216 with additional engagement options.

In an embodiment, the second set of metaverse services 214 may include a third metaverse service 214A and a fourth metaverse service 214B. The third metaverse service 214A and the fourth metaverse service 214B may be integrated within the second metaverse environment 208 and may operate using the set of service protocols and interfaces. Further, the third metaverse service 214A and the fourth metaverse service 214B may leverage blockchain-based authentication mechanisms to validate access of the user 216 and maintain transaction records associated with the user 216. Additionally, the second metaverse environment 208 may provide a secure framework for handling digital assets, including virtual goods, cryptocurrencies, and non-fungible tokens (NFTs), ensuring seamless user interactions within the ecosystem.

In operation, the system 202 may be configured to receive the preference data of the user 216. The user 216 may be associated with the first metaverse environment 206. Based on the preference data, the system 202 may be further configured to shortlist the second metaverse environment 208 from the plurality of metaverse environments. The second metaverse environment 208 may be associated with the second distributed ledger. The system 202 may be further configured to identify the second set of metaverse services 214 that may be compatible with the first set of metaverse services 212. The system 202 may be further configured to integrate the identified second set of metaverse services 214 with the first set of metaverse services 212. The system 202 may be further configured to receive profile data associated with the user 216. The system 202 may be further configured to obtain a set of parameters from the received profile data. Examples of the set of parameters may include at least one of behavioral patterns of the user 216, historical interactions of the user 216, preference indicators of the user 216, transaction history of the user 216, and the like. The system 202 may be further configured to determine an association between the obtained set of parameters and the second set of metaverse services 214. In an embodiment, the system 202 may be further configured to apply a machine learning (ML) model on the obtained set of parameters and the second set of metaverse services 214 to determine the association.

The system 202 may be further configured to generate a digital contract based on the determined association. The digital contract may be implemented as a smart contract and may be deployed on a distributed ledger, ensuring secure, transparent, and tamper-resistant execution of metaverse services. The digital contract may define the terms governing interactions between the first set of metaverse services 212 and the second set of metaverse services 214. Details about the digital contract are provided, for example in FIG. 3A and 3B.

The system 202 may be further configured to receive context data associated with the first set of metaverse services 212. The context data includes at least one of interaction data of the user 216, behavioral data of the user 216, physiological data of the user 216, environmental data associated with the user 216, transaction data of the user 216, communication data of the user 216, external influences, and the like. Based on the received context data, the generated digital contract may be executed. The system 202 may be further configured to initiate a metaverse service of the integrated second set of metaverse services 214 based on the executed digital contract. The metaverse service is initiated with the first set of metaverse services 212.

FIGS. 3A and 3B are diagrams that collectively illustrate exemplary operations for integration of the metaverse services, in accordance with an embodiment of the disclosure. FIGS. 3A and 3B are explained in conjunction with elements from FIGS. 1, and 2 With reference to FIGS. 3A and 3B, there is shown a block diagram 300 that illustrates exemplary operations from 302 to 320, as described herein. The exemplary operations illustrated in the block diagram 300 may start at 302 and may be performed by any computing system, apparatus, or device, such as by the computer 102 of FIG. 1 or system 202 of FIG. 2. Although illustrated with discrete blocks, the exemplary operations associated with one or more blocks of the block diagram 300 may be divided into additional blocks, combined into fewer blocks, or eliminated, depending on the particular implementation.

At 302, a preference reception operation may be executed. In the preference reception operation, the system 202 may be configured to receive preference data of the user 216 from the electronic device 204. The preference data may be based on explicit user selections by the user 216, inferred behavioral patterns of the user 216, historical interaction records of the user 216, or dynamically generated insights of the user 216 based on real-time engagement within the one or more metaverse environments. Thus, the preference data may indicate the interests of the user 216, requirements of the user 216, engagement tendencies of the user 216, or past interactions of the user 216 with various digital services and virtual platforms.

In an embodiment, the preference data may include categories of interest such as gaming, educational awareness, finance, or healthcare. Additionally, the preference data may encompass metadata attributes, including but not limited to, session duration, frequency of interaction with specific services, transaction history, user-generated content preferences, and engagement with immersive or AR features. The system 202 may acquire the preference data from multiple sources, including user profiles stored on a distributed ledger, external data sources such as linked social media accounts, third-party analytics platforms, or decentralized identity systems. Based on the preference data, the system 202 may be further configured to shortlist the second metaverse environment 208 from the plurality of metaverse environments. In an embodiment, the system 202 may be further configured to evaluate that the second metaverse environment 208 includes various metaverse services (e.g., the second set of metaverse services 214) that may align with the preference data. Further, based on the evaluation, the system 202 may shortlist the second metaverse environment 208. For example, if the preference data indicates an interest in financial services and education services, the system 202 may shortlist a metaverse environment that may include financial metaverse services and educational metaverse services. Initially, the user 216 may be associated with the first metaverse environment 206. Further, the first metaverse environment 206 may be associated with the first distributed ledger, and the second metaverse environment 208 may be associated with the second distributed ledger.

At 304, it may be determined whether the user 216 consents to metaverse service integration. Based on the shortlisting of the second metaverse environment 208, the system 202 may be further configured to obtain consent from the user 216 via the electronic device 204 before proceeding with metaverse service integration. In an embodiment, the system 202 may be configured to render a consent prompt on the electronic device 204, requesting the user 216 to authorize the integration of various metaverse services (e.g., the first set of metaverse services 212 and the second set of metaverse services 214) associated with respective metaverse environments (e.g., the first metaverse environment 206 and the second metaverse environment 208). The consent prompt may include detailed information regarding the nature of integration, the types of metaverse services to be merged, any associated data-sharing policies, and security or privacy considerations.

In an embodiment, the system 202 may provide granular consent options, allowing the user 216 to selectively authorize specific data-sharing policies while rejecting additional data-sharing policies. Additionally, the system 202 may implement multi-factor authentication (MFA) or biometric verification mechanisms to validate the identity of the user 216 before registering consent. In case the user 216 declines to consent to the metaverse service integration, the control may pass to end 306. Alternatively, in case the user 216 provides consent to the metaverse service integration, the control may pass to 308. The system 202 may be configured to store a record of the user consent on the first distributed ledger to ensure immutability, transparency, and compliance with regulatory standards that may govern digital service integrations. In an embodiment, the first distributed ledger and the second distributed ledger may be identical such that data consistency and interoperability are inherently maintained through a unified ledger structure. In various embodiments, the first distributed ledger and the second distributed ledger may be different such that secure data sharing and interoperability may be provided through cross-chain communication protocols, such as blockchain oracles, or interoperability frameworks (e.g., sidechains or bridge contracts).

At 308, a metaverse service identification operation may be executed. In the metaverse service identification operation, the system 202 may be configured to identify the second set of metaverse services 214 that may align with the preference data. The second set of metaverse services 214 may be identified based on the determination that the user 216 consents to metaverse service integration. In an embodiment, the second set of metaverse services 214 may function as an auxiliary digital space that enhances or supplements the first set of metaverse services 212.

The second set of metaverse services 214 may include the third metaverse service 214A and the fourth metaverse service 214B. The third metaverse service 214A and the fourth metaverse service 214B may be integrated within the second metaverse environment 208 and may operate using the set of service protocols and interfaces. For example, the third metaverse service 214A and the fourth metaverse service 214B may leverage blockchain-based authentication mechanisms to validate access of the user 216, thereby ensuring a secure and trustless verification process. Further, the third metaverse service 214A and the fourth metaverse service 214B may leverage the blockchain-based authentication mechanisms to validate access of the user 216 and maintain the transaction records associated with the user 216.

The system 202 may identify the second set of metaverse services 214 based on various factors such as the preference data, historical user interactions, contextual engagement patterns, and a set of compatibility criteria between the first metaverse environment 206 and the second metaverse environment 208. In an embodiment, a machine learning algorithm or rule-based selection framework may be employed to dynamically determine the most suitable metaverse services for integration ensuring that the identified second set of metaverse services 214 aligns with the preference of the user 216. Additionally, the identified second set of metaverse services 214 may operate efficiently within an overall digital ecosystem offered by the system 202.

Although it is mentioned that the system 202 may be configured to identify the second set of metaverse services 214, in various embodiments, the identification of the second set of metaverse services 214 may be governed by an administrative policy, a set of rules, an administrator, or a combination thereof.

At 310, a metaverse service integration operation may be executed. In the metaverse service integration operation, the system 202 may be configured to generate a set of service level agreements (SLAs) between the first metaverse environment 206 and the second metaverse environment 208. The generated set of SLAs may define the terms, conditions, and protocols under which the first metaverse environment 206 and the second metaverse environment 208 operate in conjunction. In an embodiment, the system 202 may be configured to generate the set of SLAs dynamically based on various parameters, including but not limited to, the compatibility of the first metaverse environment 206 and second metaverse environment 208, the technical infrastructure requirements, security compliance standards, and data exchange policies.

The generated set of SLAs includes at least one of a commercial agreement between the first metaverse environment 206 and the second metaverse environment 208, a technical agreement between the first metaverse environment 206 and the second metaverse environment 208, an operational agreement between the first metaverse environment 206 and the second metaverse environment 208, or a governance agreement between the first metaverse environment 206 and the second metaverse environment 208.

In various embodiments, the commercial agreement may define financial terms such as revenue-sharing models, subscription fees, licensing arrangements, or monetization strategies for the metaverse services to be integrated. For example, if the first metaverse environment 206 is an educational platform and the second metaverse environment 208 offers interactive AI-driven tutoring services, the commercial agreement may specify the revenue distribution when the user 216 accesses premium tutoring features between a first service provider offering the first metaverse environment 206 and a second service provider offering the second metaverse environment 208.

In various embodiments, the technical agreement may define interoperability standards, communication protocols, data formats, application programming interface (API) specifications, and infrastructure compatibility measures that provide seamless data exchange and service integration. For example, the first metaverse environment 206 integrating financial services from the second metaverse environment 208 may require blockchain-based payment processing mechanisms to align with existing decentralized finance (DeFi) protocols.

In various embodiments, the operational agreement may define the functional and performance-related expectations of the integrated services, including service availability, latency requirements, scalability provisions, and maintenance responsibilities. For example, if the first metaverse environment 206 is a retail shopping platform and the second metaverse environment 208 provides AR-enabled virtual fitting rooms, the operational agreement may establish performance benchmarks for rendering AR models in real-time.

In various embodiments, the governance agreement may define compliance requirements, data privacy policies, security mandates, and intellectual property rights associated with the integrated services. For example, a financial service within the second metaverse environment 208 may require adherence to regulatory standards such as know-your-customer (KYC) policies before being integrated into the first metaverse environment 206.

The set of SLAs is generated based on the identification of the second set of metaverse services 214. The system 202 may be configured to integrate the identified second set of metaverse services 214 with the first set of metaverse services 212 based on the set of SLAs. The integration is based on at least one of the APIs, middleware applications, or data mapping strategies.

In an embodiment, the system 202 may employ the APIs to provide data exchange and functional interoperability between the first metaverse environment 206 and the second metaverse environment 208. Examples of the APIs may include representational state transfer (RESTful) APIs, GraphQL APIs, or WebSocket-based APIs, that enable real-time communication and interaction between the first metaverse environment 206 and the second metaverse environment 208. For example, if the first metaverse environment 206 is a social networking platform and the second metaverse environment 208 provides virtual event hosting services, the APIs may be used to synchronize an avatar of the user 216, event participation status, and interactive elements across the first metaverse environment 206 and the second metaverse environment 208.

In various embodiments, the system 202 may deploy the middleware applications that act as an intermediary layer to provide interoperability between the first metaverse environment 206 and the second metaverse environment 208. The middleware applications may handle protocol conversion, data transformation, and service orchestration to ensure seamless integration. For example, when the first metaverse environment 206 operates on a centralized infrastructure while the second metaverse environment 208 is based on decentralized blockchain architecture, middleware applications may bridge the differences in data structures, authentication mechanisms, and transaction processing methods.

In various embodiments, the first metaverse environment 206 and the second metaverse environment 208 may include diverse data models. The system 202 may use the data mapping strategies to align data associated with the user 216, and service-specific information across the first metaverse environment 206 and the second metaverse environment 208. The data mapping strategies may include schema transformation, ontology alignment, or machine learning-based data normalization techniques to ensure compatibility between the diverse data models. For example, if the first metaverse environment 206 maintains user profiles using a proprietary database format while the second metaverse environment 208 relies on a distributed ledger, data mapping strategies may be implemented to synchronize identity attributes, transaction histories, and access privileges consistently and securely.

At 312, a data reception operation may be executed. In the data reception operation, the system 202 may be configured to receive the profile data associated with the user 216. The system 202 may be configured to obtain the set of parameters from the received profile data. The set of parameters may include behavioral patterns of the user 216, historical interactions of the user 216, preference indicators (e.g., interests in gaming, educational content, finance, or healthcare) of the user 216, and transaction history of the user 216 biometric information associated with the user 216, behavioral analytics associated with the user 216, and the like. For example, the set of parameters may include prior engagement patterns of the user 216 within the first metaverse environment 206, such as the frequency and duration of interactions with specific services, as well as contextual information like the time of access and preferred device characteristics.

The system 202 may be configured to determine an association (e.g., mapping) between the obtained set of parameters and the second set of metaverse services 214. The association may define a structured correlation between the obtained set of parameters (e.g., preferences, behavioral patterns, and the like) and different metaverse services of the second set of metaverse services 212. For example, if the obtained set of parameters indicates that the user 216 exhibits a preference for educational content during certain time periods, the system 202 may determine an association between the obtained set of parameters and specialized educational metaverse service of the second set of metaverse services 214. In an embodiment, the system 202 may use a machine learning model or a rule-based decision framework to continuously update the association between the obtained set of parameters and the second set of metaverse services 214. Thus, the system 202 ensures that the determined association reflects recent user preferences and integration requirements, thereby providing a robust foundation for seamless metaverse service integration. Further, the association may correspond to at least one of a one-to-one association (e.g., a single parameter may be linked to a metaverse service of the second set of metaverse services 214), a one-to-many association (e.g., the single parameter may be linked to one or more metaverse service of the second set of metaverse services 214), or a many-to-one association (e.g., multiple parameters may be linked with the second set of metaverse services 214).

At 314, a digital contract generation operation may be executed. In the digital contract generation operation, the system 202 may be configured to generate the digital contract based on the determined association between the obtained set of parameters and the second set of metaverse services 214. Further, the system 202 may be configured to store the digital contract on the first distributed ledger. The digital contract may correspond to a self-executing digital agreement deployed on the first distributed ledger such that terms and conditions of execution are encoded in computer-readable instructions. The digital contract ensures autonomous enforcement, validation, and execution of the set of rules governing the execution of the second set of metaverse services 214 with the first set of metaverse services 212, thereby enabling trustless and verifiable interactions between the respective metaverse environments.

The system 202 may be configured to receive context data associated with the first set of metaverse services 212. The context data may include at least one of the interaction data of the user 216, behavioral data associated with the user 216, physiological data associated with the user 216, environmental data associated with the first metaverse environment 206, transaction data associated with the user 216, communication data associated with the user 216, or external influences. For example, the context data may correspond to the real-time interaction of the user 216 with the first set of metaverse services 212. The real-time interactions may include textual queries, voice commands, or gestures of the user 216 within the first metaverse environment 206. Further, the system 202 may be configured to apply natural language processing (NLP) techniques to interpret the textual queries. Based on the application of the NLP techniques, the system may be configured to determine the interest of the user 216. Additionally, the system 202 may be further configured to extract relevant keywords and gestures from the voice commands and the gestures, respectively. Based on the extraction of the relevant keywords and gestures, the system may be configured to determine the interest of the user 216.

The context data may further include user preferences, temporal factors, geolocation and environmental context, device-specific constraints, sentiment analysis, and the like. For example, the system 202 may determine the hardware and software capabilities of the electronic device 204 used by the user 216 to ensure seamless metaverse service initiation. In an embodiment, if the electronic device 204 is a VR headset with limited processing power, the digital contract may prioritize lightweight or cloud-based services to enhance performance efficiency. Alternatively, if the electronic device 204 is a performance computing system, the digital contract may enable graphically intensive services such as real-time rendering of immersive virtual experiences.

In an embodiment, the system 202 may be further configured to evaluate the received context data based on a set of criteria that may include the interaction frequency of the user 216, engagement duration of the user 216, behavioral indicators of the user 216, and the like. By way of example, and not by limitation, the set of criteria may correspond to a total engagement duration of the user 216 with the first set of metaverse services 212 to exceed five minutes and detection of keywords such as financing, loan, or subsidy to indicate interest of the user 216 in purchasing a vehicle. The system 202 may be further configured to generate a trigger based on the evaluation of the context data. Further, the generated digital contract may be executed based on the generated trigger. Although it is mentioned that the trigger may be generated based on the evaluation of the context data, in various embodiments, the trigger may be generated based on a set of algorithms that correlates specific parameters from the context data such as time of day, device type, geographical location, and the like.

At 316, a metaverse service initiation operation may be executed. In the metaverse service initiation operation, the system 202 may be configured to initiate a metaverse service of the second set of metaverse services 214 based on the executed digital contract. In an embodiment, the system 202 may be further configured to parse the digital contract. The parsing of the digital contract may correspond to interpreting the machine-readable code of the digital contract to extract various conditions, and rules to identify execution elements such as a metaverse service of the second set of metaverse services 214 to be activated, along with any associated execution parameters such as time constraints, access privileges, or resource allocation requirements. For example, if the executed digital contract specifies the initiation of a financial advisory metaverse service from the second set of metaverse services 214, the system 202 may automatically establish a secure network connection with the corresponding service module, allocate processing resources, and configure a user interface to display relevant financial data and interactive tools. In an embodiment, the metaverse service initiation operation may include invoking standardized APIs, deploying middleware components to provide data translation, and leveraging blockchain-based authentication mechanisms to verify the credentials of the user 216 before the initiation of the financial advisory metaverse service.

In an embodiment, the initiated metaverse service (e.g., the financial advisory metaverse service) may be implemented in various forms to deliver the intended functionality. For example, the metaverse service may take the form of a service avatar that may correspond to an artificial intelligence (AI) driven digital agent that engages the user 216 in natural language dialogue and provides personalized financial guidance. Alternatively, the metaverse service may be rendered as an interactive screen or portal that offers a dynamic dashboard, aggregating real-time financial indicators, analytical tools, and multimedia content tailored as per the requirements of the user 216. In various embodiments, the initiated metaverse service may combine these elements, such as a virtual kiosk that enables the user to navigate between multiple metaverse service options, interact with AI-powered assistants, and execute transactions directly within the first metaverse environment 206.

At 318, a feedback reception operation may be executed. In the feedback reception operation, the system 202 may be configured to receive feedback data based on the initiation of the metaverse service. The feedback data may correspond to a result of an interaction experience of the user 216 with the initiated metaverse service. For example, the feedback data may include direct inputs such as service ratings, textual comments, or selections from a set of response options. Additionally, the feedback data may include indirect metrics such as session duration, engagement frequency, and biometric indicators of user satisfaction. The system 202 may be configured to log the feedback data on the first distributed ledger. The first distributed ledger ensures that recorded feedback data is cryptographically verified, timestamped, and maintained in a tamper-resistant format, thus providing an auditable record of interactions of the user 216 and service performance.

For example, if the user 216 rates a newly integrated educational metaverse service of the second set of metaverse services 214 with a five start satisfaction score, the feedback data may be stored on the first distributed ledger and can later be referenced to adjust various parameters for the digital contract, refine service offerings, or trigger automated updates to the user profile. Thus, the system 202 ensures transparency, and accountability, and enables continuous improvement for the integration and initiation of the metaverse services through data-driven adjustments by leveraging the feedback data.

The system 202 may be further configured to determine a success rate associated with the initiated metaverse service based on the feedback data. In an embodiment, the success rate may correspond to the completion of an activity associated with the initiated metaverse service (e.g., purchase an item offered by the initiated metaverse service). Additionally, the system 202 may be configured to determine a set of performance metrics, including service effectiveness operational efficiency, and user engagement levels based on the feedback data. In an embodiment, the service effectiveness may be determined based on various factors such as task completion accuracy, user satisfaction ratings, and the extent to which the initiated metaverse service meets the objectives of the user 216. The operational efficiency may be determined based on key performance indicators (KPIs) such as the average task completion rate, the average time taken per task, and resource utilization during the execution of the initiated metaverse service. The system 202 may be further configured to log the success rate and the set of performance metrics on the first distributed ledger.

At 320, a digital contract update operation may be executed. In the digital contract update operation, the system 202 may be configured to update the association between the obtained set of parameters and the second set of metaverse services 214. The association may be updated based on the logged feedback data. In an embodiment, the system 202 may apply adaptive learning techniques or rule-based algorithms to dynamically refine or update the association, thereby ensuring that the initiation of the second set of metaverse services 214 remain contextually relevant and aligned with evolving user preferences.

The system 202 may be further configured to update the digital contract based on the updated association, the success rate, and the set of performance metrics. For example, if the logged feedback data indicates that the financial advisory metaverse service (initiated as the service avatar) has a user engagement rate below a threshold rate due to delayed response times, the system 202 may update the digital contract to adjust service parameters such as modifying resource allocation or specifying a transition to an alternative service metaverse with improved responsiveness. Alternatively, if the logged feedback data reflects a shift in sentiments of the user or preferences of the user, such as a decline in satisfaction ratings for an interactive screen that displays financial analytics, the system 202 may update the digital contract to alter the access privileges, timing constraints, or even substitute the current metaverse service with a different metaverse service to better align with preferences of the user 216.

In an embodiment, the digital contract update operation may be based on various verification protocols associated with the first distributed ledger to ensure that any modifications adhere to security compliance and interoperability standards. Once updated, the digital contract is redeployed on the first distributed ledger, thereby ensuring that subsequent interactions and integrations within the first metaverse environment 206 and the second metaverse environment 208 are governed by the most recent and optimized execution parameters. Thus, the system 202 ensures that the integration and initiation of the metaverse service remain adaptive and responsive, thereby enhancing overall user satisfaction and operational efficiency.

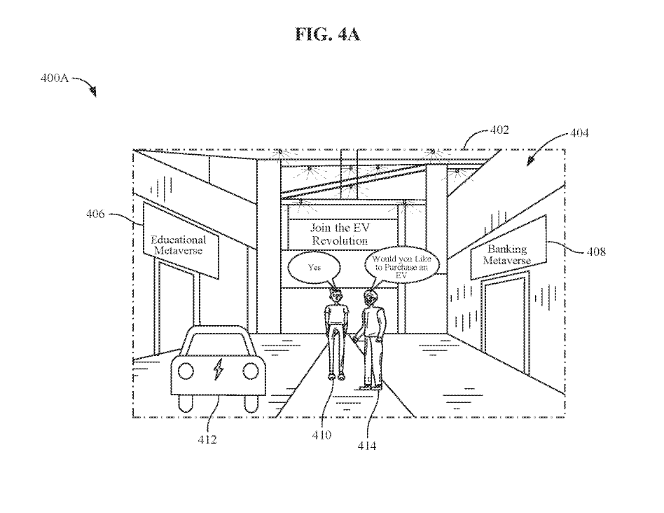

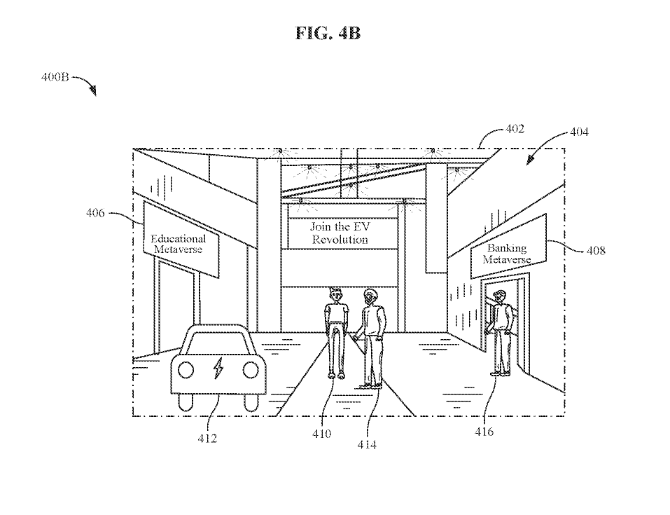

FIG. 4A is a diagram that illustrates a first exemplary scenario 400A for the integration of the metaverse services, in accordance with an embodiment of the disclosure. FIG. 4A is explained in conjunction with elements from FIGS. 1, 2, 3A, and 3B. The first exemplary scenario 400A indicates an integrated metaverse environment 402 that may correspond to an integration of one or more metaverse environments. For the sake of brevity, it is assumed that the integrated metaverse environment 402 is a combination of an automotive metaverse environment 404, an educational metaverse environment 406, and a banking metaverse environment 408. Further, the system 202 generates the digital contract based on the profile data associated with the user 216. The automotive metaverse environment 404 may be associated with a first service provider that may correspond to a car dealership. The educational metaverse environment 406 may be associated with a second service provider that may correspond to an electronic learning (e-learning) platform. Additionally, the banking metaverse environment 408 may be associated with a third service provider that may correspond to a first financial institution.

The integrated metaverse environment 402 includes a user avatar 410 associated with the user 216 and an electric vehicle (EV) 412. In an embodiment, the integrated metaverse environment 402 provides an immersive virtual space such that the EV 412 may correspond to a virtual replica model of an EV. The user avatar 410 may interact with the EV 412 in the integrated metaverse environment 402. Further, the system 202 receives the context data associated with the user 216. The context data may correspond to explicit actions of the user avatar 410 within the integrated metaverse environment 402, behavioral indicators associated with the user 216, or predictive assessments based on historical data associated with the user 216.

In an embodiment, initially, the integrated metaverse environment 402 may only include a service representative avatar 414 as a first metaverse service associated with the automotive metaverse environment 404. Further, the context data may include direct user actions such as viewing the EV 412 for detailed inspection, enquiring about the EV 412 specifications, and the like. For example, as shown in FIG. 4A, the service representative avatar 414 may initiate an inquiry with the user avatar 410 by asking “Would you like to purchase an EV”. In response to the inquiry, the user avatar 410 may respond with “yes”, thereby indicating interest in purchasing the EV (e.g., the EV 412). Thus, the response may correspond to the context data. The system 202 may be configured to receive the context data from the integrated metaverse environment 402. Based on the context data, the system 202 may be configured to apply the ML model on the context data to generate the trigger. Based on the generated trigger, the digital contract may execute automatically. Further, the system 202 may be configured to initiate a second metaverse service associated with the banking metaverse environment 408. Details about the second metaverse service are provided, for example, in FIG. 4B.

In various embodiments, the user avatar 410 may have shown interest in purchasing the EV 412 and may have started the paperwork. The system 202 may be configured to store the paperwork initiation to purchase the EV 412 as the context data. Further, when the user avatar 410 may enter the banking metaverse environment 408, the system 202 may be configured to retrieve the stored context data. Based on the retrieval of the context data, the system 202 may initiate the second metaverse service within the banking metaverse environment 408.

FIG. 4B is a diagram that illustrates a second exemplary scenario 400B for the integration of the metaverse services, in accordance with an embodiment of the disclosure. FIG. 4B is explained in conjunction with elements from FIGS. 1, 2, 3A, 3B, and 4A. The second exemplary scenario 400B indicates the integrated metaverse environment 402 that may correspond to the integration of one or more metaverse environments. Based on the initiation of the second metaverse service, the integrated metaverse environment 402 may further include a finance advisor avatar 416 as the second metaverse service associated with the banking metaverse environment 408.

The finance advisor avatar 416 may correspond to a virtual banking representative to assist the user avatar 410 with financing options for purchasing the EV 412. The finance advisor avatar 416 may be an AI-driven digital entity that engages in interactive discussions with the user avatar 410, providing tailored recommendations based on the financial profile of the user 216, credit history, and available loan options. The finance advisor avatar 416 may also provide real-time simulations of financing plans, allowing the user 216 to compare various loan terms, interest rates, and monthly payment structures. Additionally, the finance advisor avatar 416 may be configured to verify user credentials via blockchain-based authentication mechanisms and, upon successful validation, initiate loan pre-approval processes directly within the integrated metaverse environment 402.

In various embodiments, initially, the integrated metaverse environment 402 may only include the service representative avatar 414 as the first metaverse service. Further, the context data may include implicit behavioral indicators associated with the user 216, or predictive assessments based on the historical data associated with the user 216 indicative of a potential interest in purchasing the EV 412. For example, the system 202 may have access to a financial profile associated with the user 216, a vehicle service history associated with the user 216, and the like. The access may be based on the consent of the user 216. Further, the system 202 may be configured to detect that the user 216 may have received a salary bonus above a threshold amount, and the system 202 may link the salary bonus with increased purchasing power. Additionally, the system 202 may be configured to detect persistent mechanical issues with a previously owned internal combustion engine (ICE) vehicle, and engagement with EV-related content. The system 202 may be further configured to apply a machine learning model on the context data to generate the trigger. Based on the generated trigger, the digital contract may execute automatically. Additionally, the system 202 may be further configured to initiate a third metaverse service that may be associated with the educational metaverse environment. For example, the system 202 may initiate an information portal as the third metaverse service.

The information portal may correspond to a digital interface configured to present relevant government subsidy programs and financial incentives for the purchase of the EV 412. In an embodiment, the information portal may retrieve real-time data from regulatory databases and governmental sources to provide updated details on available rebates, tax credits, and incentive programs applicable to a geographical region associated with the user 216. The information portal may further customize subsidy information based on user-specific eligibility criteria, such as income levels, prior vehicle ownership, or location-based incentives. Additionally, the information portal may integrate interactive features, such as calculators to estimate the total savings based on subsidy eligibility and provide direct links to government agencies or a second financial institution for subsidy applications.

The user avatar 410 may be further directed to a payment gateway, in case the user 216 is ready to purchase the EV 412. In an embodiment, the payment gateway may be a secure digital metaverse service associated with the banking metaverse environment 408. The payment gateway may support multiple payment methods, including direct bank transfers, cryptocurrency transactions, digital wallets, and installment-based financing options. Additionally, the system 202 may be configured to verify payment credentials associated with the user 216 using blockchain-based authentication mechanisms, ensuring a secure and fraud-resistant transaction process. Further, in case the user avatar 410 opts for financing, the payment gateway may interface with the second financial institution associated with the finance advisor avatar 416 to apply for a loan. Further, the payment gateway may dynamically adjust the payment structure based on pre-approved financing terms, allowing the user avatar 410 to select a preferred down payment amount and installment plan. The system 202 may be further configured to update a profile associated with the user 216 (or the user avatar 410) on the first distributed ledger to maintain a verifiable and immutable record of the purchase. Additionally, based on the update profile, the system 202 may be configured to generate personalized recommendations for the user 216 such as trade-in options for future vehicle updates, insurance plans, extended warranties, scheduled maintenance packages, and the like.

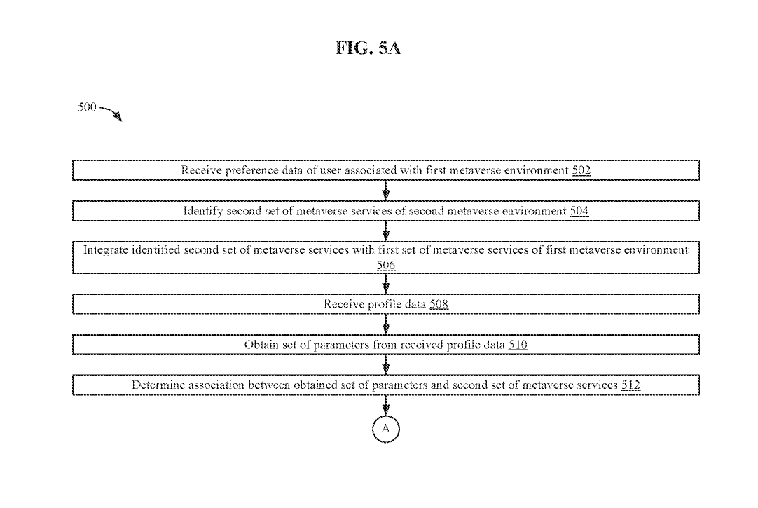

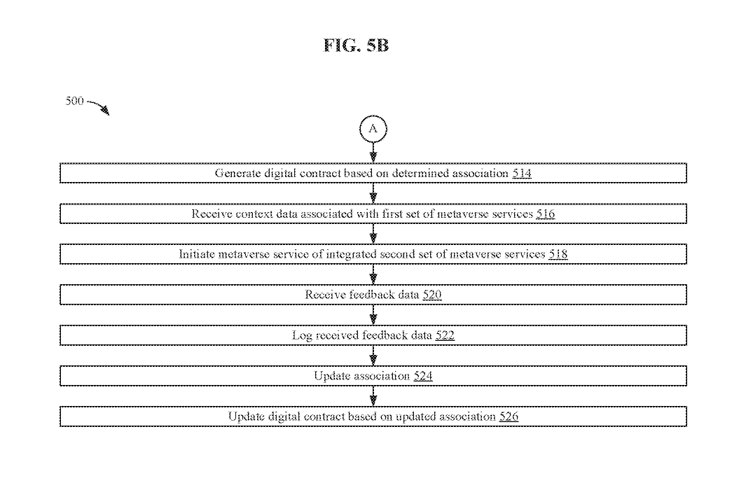

FIGS. 5A and 5B are diagrams that collectively illustrate a flowchart of an exemplary method for integration of the metaverse services, in accordance with an embodiment of the disclosure. FIGS. 5A and 5B are explained in conjunction with elements from FIGS. 1, 2, 3A, 3B, 4A, and 4B. With reference to FIGS. 5A and 5B, there is shown a flowchart 500. The operations of the exemplary method may be executed by any computing system, for example, by the computer 102 of FIG. 1 or the system 202 of FIG. 2. The operations of the flowchart 500 may start at 502.

Referring now to FIG. 5A, at 502, the preference data of the user 216 is received. In an embodiment of the disclosure, the system 202 may be configured to receive the preference data of the user 216 associated with the first metaverse environment 206. The preference data may be based on explicit user selections by the user 216, inferred behavioral patterns of the user 216, historical interaction records of the user 216, or dynamically generated insights of the user 216 based on real-time engagement within the one or more metaverse environments. Thus, the preference data may indicate the interests of the user 216, requirements of the user 216, engagement tendencies of the user 216, or past interactions of the user 216 with various digital services and virtual platforms. Based on the preference data, the system 202 may be further configured to shortlist the second metaverse environment 208 from the plurality of metaverse environments. Details about the reception of the preference data are provided, for example, in FIGS. 2, 3A, 3B, 4A, and 4B.

At 504, the second set of metaverse services 214 are identified. In an embodiment of the disclosure, the system 202 may be configured to identify the second set of metaverse services 214 of the second metaverse environment 208 that may align with the preference data. The second set of metaverse services 214 may be identified based on the determination that the user 216 consents to metaverse service integration. The system 202 may identify the second set of metaverse services 214 based on various factors such as the preference data, historical user interactions, contextual engagement patterns, and a set of compatibility criteria between the first metaverse environment 206 and the second metaverse environment 208. Details about the identification of the second set of metaverse services 214 are provided, for example, in FIGS. 2, 3A, 3B, 4A, and 4B.

At 506, the identified second set of metaverse services 214 are integrated with the first set of metaverse services 212. In an embodiment of the disclosure, the system 202 may be configured to generate a set of service level agreements (SLAs) between the first metaverse environment 206 and the second metaverse environment 208. The generated set of SLAs may define the terms, conditions, and protocols under which the first metaverse environment 206 and the second metaverse environment 208 operate in conjunction. In an embodiment, the system 202 may be configured to generate the set of SLAs dynamically based on various parameters, including but not limited to, the compatibility of the first metaverse environment 206 and second metaverse environment 208, the technical infrastructure requirements, security compliance standards, and data exchange policies. The system 202 may be configured to integrate the identified second set of metaverse services 214 with the first set of metaverse services 212 of the first metaverse environment 206 based on the set of SLAs. The integration is based on at least one of the APIs, middleware applications, or data mapping strategies. Details about the integration of the identified second set of metaverse services 214 are provided, for example, in FIGS. 2, 3A, 3B, 4A, and 4B.

At 508, the profile data is received. In an embodiment of the disclosure, the system 202 may be configured to receive the profile data associated with the user 216. The profile data may include a unique identifier associated with the user 216, demographic details associated with the user 216, explicit service preferences associated with the user 216 (e.g., interests in gaming, educational content, finance, or healthcare), historical interaction logs of the user 216, transaction histories of the user 216, biometric information associated with the user 216, behavioral analytics associated with the user 216, and the like. Details about the reception of the profile data are provided, for example, in FIGS. 2, 3A, 3B, 4A, and 4B.

At 510, the set of parameters is obtained based on the received profile data. In an embodiment of the disclosure, the system 202 may be configured to obtain the set of parameters from the received profile data. The set of parameters may include behavioral patterns of the user 216, historical interactions of the user 216, preference indicators (e.g., interests in gaming, educational content, finance, or healthcare) of the user 216, and transaction history of the user 216 biometric information associated with the user 216, behavioral analytics associated with the user 216, and the like. Details about the obtaining of the set of parameters are provided, for example, in FIGS. 2, 3A, 3B, 4A, and 4B.

At 512, the association between the obtained set of parameters and the second set of metaverse services 214 is determined. In an embodiment of the disclosure, the system 202 may be configured to determine the association (e.g., mapping) between the obtained set of parameters and the second set of metaverse services 214. The association may define a structured correlation between the obtained set of parameters (e.g., preferences, behavioral patterns, and the like) and different metaverse services of the second set of metaverse services 212. Details about the determination of the association are provided, for example, in FIGS. 2, 3A, 3B, 4A, and 4B.

Referring now to FIG. 5B, at 514, the digital contract is generated based on the determined association. In an embodiment of the disclosure, the system 202 may be configured to generate the digital contract based on the determined association. Further, the system 202 may be configured to store the digital contract on the first distributed ledger. The digital contract may correspond to a self-executing digital agreement deployed on the first distributed ledger such that terms and conditions of execution are encoded in computer-readable instructions. The digital contract ensures autonomous enforcement, validation, and execution of the set of rules governing the execution of the second set of metaverse services 214 with the first set of metaverse services 212, thereby enabling trustless and verifiable interactions between the respective metaverse environments. Details about the generation of the digital contract are provided, for example, in FIGS. 2, 3A, 3B, 4A, and 4B.

At 516, the context data associated with the first set of metaverse services 212 is received. In an embodiment of the disclosure, the system 202 may be configured to receive the context data associated with the first set of metaverse services 212. The context data may include at least one of the interaction data of the user 216, behavioral data associated with the user 216, physiological data associated with the user 216, environmental data associated with the first metaverse environment 206, transaction data associated with the user 216, communication data associated with the user 216, or external influences. The context data may further include user preferences, temporal factors, geolocation and environmental context, device-specific constraints, sentiment analysis, and the like. The system 202 may be further configured to generate the trigger based on the context data. Details about the reception of the context data are provided, for example, in FIGS. 2, 3A, 3B, 4A, and 4B.

At 518, a metaverse service of the integrated second set of metaverse services 214 is initiated. In an embodiment of the disclosure, the system 202 may be configured to initiate the metaverse service of the second set of metaverse services 214 based on the executed digital contract. In an embodiment, the system 202 may be further configured to parse the digital contract. The parsing of the digital contract may correspond to interpreting the machine-readable code of the digital contract to extract various conditions, and rules to identify execution elements such as a metaverse service of the second set of metaverse services 214 to be activated, along with any associated execution parameters such as time constraints, access privileges, or resource allocation requirements. Details about the initiation of the metaverse service are provided, for example, in FIGS. 2, 3A, 3B, 4A, and 4B.

At 520, the feedback data is received. In an embodiment of the disclosure, the system 202 may be configured to receive feedback data based on the initiation of the metaverse service. The feedback data may correspond to a result of an interaction experience of the user 216 with the initiated metaverse service. For example, the feedback data may include direct inputs such as service ratings, textual comments, or selections from the set of response options. Additionally, the feedback data may include indirect metrics such as session duration, engagement frequency, and biometric indicators of user satisfaction. Details about the reception of the feedback data are provided, for example, in FIGS. 2, 3A, 3B, 4A, and 4B.

At 522, the received feedback data is logged. In an embodiment of the disclosure, the system 202 may be configured to log the feedback data on the first distributed ledger. The first distributed ledger ensures that the recorded feedback data is cryptographically verified, timestamped, and maintained in a tamper-resistant format, thus providing an auditable record of interactions of the user 216 and service performance. The system 202 may be further configured to determine a success rate associated with the initiated metaverse service based on the feedback data. In an embodiment, the success rate may correspond to the completion of an activity associated with the initiated metaverse service (e.g., purchase an item offered by the initiated metaverse service). Details about the logging of the received feedback data are provided, for example, in FIGS. 2, 3A, 3B, 4A, and 4B.

At 524, the association between the obtained set of parameters and the second set of metaverse services 214 is updated. In an embodiment of the disclosure, the system 202 may be configured to update the association. The association may be updated based on the logged feedback data. In an embodiment, the system 202 may apply adaptive learning techniques or rule-based algorithms to dynamically refine or update the association, thereby ensuring that the initiation of the second set of metaverse services 214 remain contextually relevant and aligned with evolving user preferences. Details about the updating of the association are provided, for example, in FIGS. 2, 3A, 3B, 4A, and 4B.

At 526, the digital contract is updated. In an embodiment of the disclosure, the system 202 may be configured to update the digital contract based on the updated association, the success rate, and the set of performance metrics. For example, if the logged feedback data indicates that the financial advisory metaverse service (initiated as the service avatar) has the user engagement rate below the threshold rate due to delayed response times, the system 202 may update the digital contract to adjust service parameters such as modifying resource allocation or specifying a transition to an alternative service metaverse with improved responsiveness. Alternatively, if the logged feedback data reflects a shift in sentiments of the user or preferences of the user, such as a decline in satisfaction ratings for an interactive screen that displays financial analytics, the system 202 may update the digital contract to alter the access privileges, timing constraints, or even substitute the current metaverse service with a different metaverse service to better align with preferences of the user 216. Details about the updating of the digital contract are provided, for example, in FIGS. 2, 3A, 3B, 4A, and 4B.

The descriptions of the various embodiments of the disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable a reader of ordinary skill in the art to understand the embodiments disclosed herein.

What is claimed is:

1. A computer-implemented method, comprising:
identifying, by a computer, a first set of metaverse services of a first metaverse environment, wherein the first metaverse environment is associated with a first distributed ledger;
integrating, by the computer, the identified first set of metaverse services with a second set of metaverse services of a second metaverse environment, wherein the second metaverse environment is associated with a second distributed ledger;
receiving, by the computer, profile data associated with a user, wherein the user is associated with the second metaverse environment;
obtaining, by the computer, a set of parameters from the received profile data;
determining, by the computer, an association between the obtained set of parameters and the integrated first set of metaverse services;
generating, by the computer, a digital contract based on the determined association;
receiving, by the computer, context data associated with the second set of metaverse services, wherein the generated digital contract is executed based on the reception of the context data; and
initiating, by the computer, a metaverse service of the integrated first set of metaverse services based on the executed digital contract, wherein the metaverse service is initiated with the second set of metaverse services.

2. The computer-implemented method of claim 1, further comprising:
receiving, by the computer, feedback data based on the initiation of the metaverse service;
logging, by the computer, the received feedback data on the second distributed ledger;
updating, by the computer, the association between the obtained set of parameters and the integrated first set of metaverse services, wherein the association is updated based on the logged feedback data; and
updating, by the computer, the digital contract based on the updated association.

3. The computer-implemented method of claim 2, further comprising:
determining, by the computer, a success rate associated with the initiated metaverse service, wherein the success rate is determined based on the received feedback data; and
logging, by the computer, the determined success rate on the second distributed ledger, wherein the association is updated based on the logged success rate.

4. The computer-implemented method of claim 1, further comprising:
generating, by the computer, a set of service level agreements (SLAs) between the first metaverse environment and the second metaverse environment, wherein the set of SLAs is generated based on the identification of the first set of metaverse services; and
integrating, by the computer, the identified first set of metaverse services with the second set of metaverse services based on the generated set of SLAs.

5. The computer-implemented method of claim 4, wherein the generated set of SLAs comprises at least one of a commercial agreement, a technical agreement, an operational agreement, or a governance agreement.

6. The computer-implemented method of claim 1, further comprising generating, by the computer, a trigger based on the reception of the context data, wherein the generated digital contract is executed based on the generated trigger.

7. The computer-implemented method of claim 1, wherein the integration is based on at least one of application programming interfaces (APIs), middleware applications, or data mapping strategies.

8. The computer-implemented method of claim 1, wherein the first distributed ledger is identical to the second distributed ledger.

9. The computer-implemented method of claim 1, wherein the context data comprises at least one of interaction data, behavioral data, physiological data, environmental data, transaction data, communication data, or external influences.

10. The computer-implemented method of claim 1, wherein the obtained set of parameters comprises to at least one of behavioral patterns, historical interactions, preference indicators, and transaction history.

11. A computer system, comprising:
a processor set;
one or more computer-readable storage media; and
program instructions stored on the one or more computer-readable storage media, the program instructions executable by the processor set to cause the processor set to:
identify a first set of metaverse services of a first metaverse environment, wherein the first metaverse environment is associated with a first distributed ledger;
integrate the identified first set of metaverse services with a second set of metaverse services of a second metaverse environment, wherein the second metaverse environment is associated with a second distributed ledger;
receive profile data associated with a user, wherein the user is associated with the second metaverse environment;
obtain a set of parameters from the received profile data;
determine an association between the obtained set of parameters and the integrated first set of metaverse services;
generate a digital contract based on the determined association;
receive context data associated with the second set of metaverse services, wherein the generated digital contract is executed based on the reception of the context data; and
initiate a metaverse service of the integrated first set of metaverse services based on the executed digital contract, wherein the metaverse service is initiated with the second set of metaverse services.

12. The computer system of claim 11, wherein the program instructions further cause the processor set to:
receive feedback data based on the initiation of the metaverse service;
log the received feedback data on the second distributed ledger;
update the association between the obtained set of parameters and the integrated first set of metaverse services, wherein the association is updated based on the logged feedback data; and
update the digital contract based on the updated association.

13. The computer system of claim 12, wherein the program instructions further cause the processor set to:
determine a success rate associated with the initiated metaverse service, wherein the success rate is determined based on the received feedback data; and
log the determined success rate on the second distributed ledger, wherein the association is updated based on the logged success rate.

14. The computer system of claim 11, wherein the program instructions further cause the processor set to:
generate a set of service level agreements (SLAs) between the first metaverse environment and the second metaverse environment, wherein the set of SLAs is generated based on the identification of the first set of metaverse services; and
integrate the identified first set of metaverse services with the second set of metaverse services, wherein the integration is based on the generated set of SLAs.

15. The computer system of claim 14, wherein the generated set of SLAs comprises at least one of a commercial agreement, a technical agreement, an operational agreement, or a governance agreement.

16. The computer system of claim 11, wherein the program instructions further cause the processor set to generate a trigger based on the reception of the context data, wherein the generated digital contract is executed based on the generated trigger.

17. The computer system of claim 11, wherein the integration is based on at least one of application programming interfaces (APIs), middleware applications, or data mapping strategies.

18. The computer system of claim 11, wherein the first distributed ledger is identical to the second distributed ledger.

19. The computer system of claim 11, wherein the context data comprises at least one of interaction data, behavioral data, physiological data, environmental data, transaction data, communication data, or external influences.

20. A computer-program product for metaverse service integration, the computer-program product comprising:
one or more computer-readable storage media; and
program instructions stored on the one or more computer-readable storage media to perform operations comprising:
identifying a first set of metaverse services of a first metaverse environment, wherein the first metaverse environment is associated with a first distributed ledger;
integrating the identified first set of metaverse services with a second set of metaverse services of a second metaverse environment, wherein the second metaverse environment is associated with a second distributed ledger;
receiving profile data associated with a user, wherein the user is associated with the second metaverse environment;
obtaining a set of parameters from the received profile data;
determining an association between the obtained set of parameters and the integrated first set of metaverse services;
generating a digital contract based on the determined association;
receiving context data associated with the second set of metaverse services, wherein the generated digital contract is executed based on the reception of the context data; and
initiating a metaverse service of the integrated first set of metaverse services based on the executed digital contract, wherein the metaverse service is initiated with the second set of metaverse services.
